(19) United States
(12) Patent Application Publication
(10) Pub. No.: US 2005/0200593 A1
(43) Pub. Date: Sep. 15, 2005

(54) Low-battery status indication for a battery-powered pointing device

(75) Inventors: Michel Willemin, Lignieres (CH); Andre Grandjean, Cressier (CH); Marc Degrauwe, Chez-le-Bart (CH); James Harold Lauffenburger, Colorado Springs, CO (US)

Correspondence Address: SUGHRUE MION, PLLC, 2100 PENNSYLVANIA AVENUE, N.W., SUITE 800, WASHINGTON, DC, 20037, US

(73) Assignee: EM MICROELECTRONIC - MARIN SA

(21) Appl. No.: 10/795,450

(22) Filed: Mar. 9, 2004

(51) Int. Cl. G09G 5/00

(52) U.S. Cl. 345/156

(57) ABSTRACT

There is described a method of providing indication of low battery status of a battery-powered pointing device designed for detecting motion and outputting motion reports representative of the detected motion, the method comprising the steps of detecting low battery status of the pointing device and affecting output of the motion reports, upon detection of the low battery status, by adding determined and/or pseudo-random components of motion to the motion reports. There is also described a method of providing indication of low battery status of a battery-powered pointing device designed for detecting motion and outputting motion reports representative of the detected motion, the pointing device controlling motion of a cursor element on a computer screen, this method comprising the steps of detecting low battery status of the pointing device and affecting motion of the cursor element on the computer screen, upon detection of the low battery status, by adding determined and/or pseudo-random components of motion to the motion of the cursor element. There is also described a method of providing indication of the low battery status consisting of affecting the graphical representation of the cursor element upon detection of the low battery status. Also described are a pointing device and software applications implementing these methods.

### FIELD OF THE INVENTION

The present invention generally relates to pointing devices (such as mice used for controlling the position of a cursor on a computer screen), i.e. pointing devices that comprise motion sensing circuit for tracking motion relative to a surface and reporting this motion to, for example, a computer. The present invention more particularly relates to battery-powered pointing devices, i.e. pointing devices that are energized by an autonomous power supply composed of one or more battery cells.

### BACKGROUND OF THE INVENTION

Pointing devices are well-known in the art. Such devices are typically used for controlling motion of a cursor element on a computer screen and can take the form of so-called mice which are displaced by the user over a work surface (such as the surface of a desktop) or so-called trackballs which include a movable actuator, i.e. a ball, that is displaced by a finger. One also knows so-called track-pads which directly track motion of a user's finger over a touch sensitive surface. Other types of pointing devices are also known which may for instance take the form of a pen.

Recently, optical pointing devices have been proposed. U.S. Pat. No. 5,288,993 for instance discloses a cursor pointing device utilizing a photodetector array and an illuminated target ball having randomly distributed speckles (i.e. a so-called trackball). U.S. Pat. No. 5,703,356 (related to the above-mentioned U.S. Pat. No. 5,288,993) further discloses (in reference to FIGS. 23A and 23B of this document) an optical cursor pointing device in the form of a mouse which does not require a ball and wherein light is reflected directly from the surface over which the pointing device is moved.

In both cases, the optical pointing device includes a light source for repetitively illuminating a surface portion (i.e. a portion of the surface of the ball or a portion of the surface over which the optical pointing device is moved) with radiation and an optical sensing unit comprising a photodetector array including a plurality of pixels each having a photosensitive element which is responsive to radiation reflected from the illuminated surface portion. The pixels outputs of the photodetector array are typically coupled to conditioning and processing circuits for tracking and extracting information about the relative motion between the sensing unit and the illuminated surface portion.

Battery-powered pointing devices, such as wireless or cordless pointing devices, become more and more popular. In contrast to conventional pointing devices which are connected to a computer by means of a cord (such as a PS/2 or USB cable) and which are generally powered by the computer through the cord, wireless or cordless pointing devices, which communicate with the computer through a wireless link (such as a radio-frequency—e.g. Bluetooth™—, acoustic, optical or inductive link), require their own power supply source so as to be energized. This power supply source is typically realized in the form of one or more battery cells which can be of a non-rechargeable or rechargeable type (typically two or three 1.5 V battery cells of type AA/LR6 or AAA/LR3). Battery-powered, non-cordless, pointing devices may be envisaged for applications where the power supply provided by the computer might not be sufficient for energizing all the components of the pointing device. In this case, the battery cell or cells would be used as a secondary or supplemental power source and might be recharged (should they be of the rechargeable type) through the cord during periods of inactivity.

One major limitation of battery-powered pointing devices resides in the relatively short life of the battery cells. This limitation is particularly critical for cordless optical pointing devices. In this latter case, battery life typically ranges from one to about six months, this duration depending on multiple factors including (i) frequency and amount of usage of the pointing device, (ii) the type and color of the surface used as reference for motion detection and (iii) the type and current capacity of the battery cells used. Limited battery life is also a problem for conventional battery-powered electromechanical pointing devices (e.g. pointing devices that use optical encoders which are driven into rotation by means of a ball).

As long as the power output of the battery cells is sufficiently high, a reliable operation of the pointing device can be ensured. When the battery cells near the end of their life, power output declines rapidly and the pointing device ultimately fails to function. It is thus common to provide the pointing device with means for monitoring the power output of the battery cell(s) and detecting when this power output falls below a certain threshold so as to inform the user of the low battery status (or end-of-life status). Upon detection of this low battery status, the user is invited to replace or recharge the battery cells before ultimate failure thereof.

Indication of the pointing device's low battery status is generally performed by warning the user through a pop-up window or message appearing on the computer screen, such operation being typically controlled and performed by a specific computer software application (or driver) provided by the pointing device's manufacturer and which is installed on the computer with which the pointing device has to communicate. This low battery status indication mechanism necessarily requires installation of the specific driver on the computer, which installation is sometimes not at all performed by the user. Another disadvantage of the above indication mechanism resides in the fact that the low battery status indication is not fed back to the user in an efficient manner. The user may for instance disregard or miss the low battery status indication and only be aware of the declining status of the pointing device's battery cells when it is too late and the pointing device completely fails to function.

Other solutions for indicating low battery status may include the provision of indication means on the pointing device itself, for instance a warning LED that flashes when the low battery status is detected. This solution is however not adequate for cordless applications, since it will be detrimental to power consumption, the warning LED and associated circuitry drawing additional power from the battery cells.

There therefore exists a need for a more adequate solution for informing the user of the low battery status of a battery-powered pointing device.

### SUMMARY OF THE INVENTION

According to a first aspect of the invention, there is provided a method of providing indication of low battery status of a battery-powered pointing device designed for detecting motion and outputting motion reports representative of the detected motion, the method comprising the steps of detecting low battery status of the pointing device and affecting output of the motion reports, upon detection of the low battery status, by adding determined and/or pseudo-random components of motion to the motion reports.

According to another aspect of the invention, there is provided a method of providing indication of low battery status of a battery-powered pointing device designed for detecting motion and outputting motion reports representative of the detected motion, the pointing device controlling motion of a cursor element on a computer screen, the method comprising the steps of detecting low battery status of the pointing device and affecting motion of the cursor element on the computer screen, upon detection of the low battery status, by adding determined and/or pseudo-random components of motion to the motion of the cursor element.

According to still another aspect of the invention, there is provided a method of providing indication of low battery status of a battery-powered pointing device designed for detecting motion and outputting motion reports representative of the detected motion, the pointing device controlling motion of a cursor element on a computer screen, the method comprising the steps of detecting low battery status of the pointing device and affecting, upon detection of the low battery status, a graphical representation of the cursor element on the computer screen.

Thanks to the above methods, the user will be informed of the low battery status of its pointing device in an efficient manner. Indeed, the user will experience a noticeable change in the way the pointing device is behaving. In applications where the pointing device is used to control the position of a cursor element on a computer screen (as in most applications of pointing devices), the user will notice that the cursor is not moving normally on the screen or that its graphical representation (i.e. the symbol representing the cursor element) is changing, thus indicating that there is something wrong with the pointing device's power supply.

The screen representation of the cursor, or cursor pointer, could for instance be changed by making the symbol flash or by switching its normal representation to another animated or non-animated graphical representation indicative of the low battery status (such as a symbol representing an empty battery or a symbol indicating “LOW BAT”, etc.). According to this embodiment, the change in the cursor's graphical representation would typically necessitate a specific software application installed on the computer. Advantageously, the cursor's graphical representation, during the low battery state, could be parameterised or selected through the software application.

Motion of the cursor on the screen can be affected in various different ways. For instance, the trace of the cursor element on the screen could form a specific message, such as “LOW” (provided that the trace of the cursor on the screen is sufficiently lasting to be perceived by the user) or motion of the cursor element could be affected to exhibit pseudo-random wiggles, jiggles or jumps during motion of the cursor and/or in no-motion state. These determined and/or pseudo-random components of motions could either be generated by the pointing device itself by programming this function into the device (no specific driver being necessary for performing the low battery status indication) or by the computer by means of an appropriate software application or driver. In this latter case, the determined and/or pseudo-random components of motions could advantageously be parameterised, in particular as to which behaviour the cursor should exhibit (tracing of a message, erratic motion, etc.) or as to when motion of the cursor should be affected (in no-motion states only, during motion, when the pointing device wakes up from a stand-by mode, etc.).

It should be pointed out that the methods consisting of affecting how motion is reported and/or displayed on a screen, are not necessarily limited to pointing devices used specifically for controlling a cursor element on a computer screen. Some application-specific pointing devices are for instance used to manipulate other types of objects on the computer screen, such as for manipulating a 3-D object in a CAD environment. The present invention could still be applied in such instance, for example by affecting how the object is manipulated. In general, “a pointing device” should be understood as being any computer control device which is designed to control displacement of an object on a computer screen.

Advantageous embodiments of the invention, such as a battery-powered pointing device and computer software applications for control of a battery-powered pointing device are the subject-matter of the claims.

Other aspects, features and advantages of the present invention will be apparent upon reading the following detailed description of non-limiting examples and embodiments made with reference to the accompanying drawing.

### BRIEF DESCRIPTION OF THE DRAWINGS

FIG. 1 is a flow chart illustrating a possible implementation of a method of providing an indication of low battery status of a battery-powered pointing device, wherein motion reported by the pointing device, upon detection of the low battery status, is affected by adding determined and/or pseudo-random components of motion to the reported motion;

FIGS. 2a and 2b are schematic illustrations of two possible ways of affecting motion of a cursor element upon detection of the low battery status;

FIG. 3 is a flow chart illustrating a possible implementation of a method of providing an indication of low battery status of a battery-powered pointing device, wherein a graphical representation of a cursor element is affected, upon detection of the low battery status; and

FIGS. 4a and 4b are schematic illustrations of two possible ways of affecting the graphical representation of the cursor element upon detection of the low battery status.

### DETAILED DESCRIPTION OF THE INVENTION

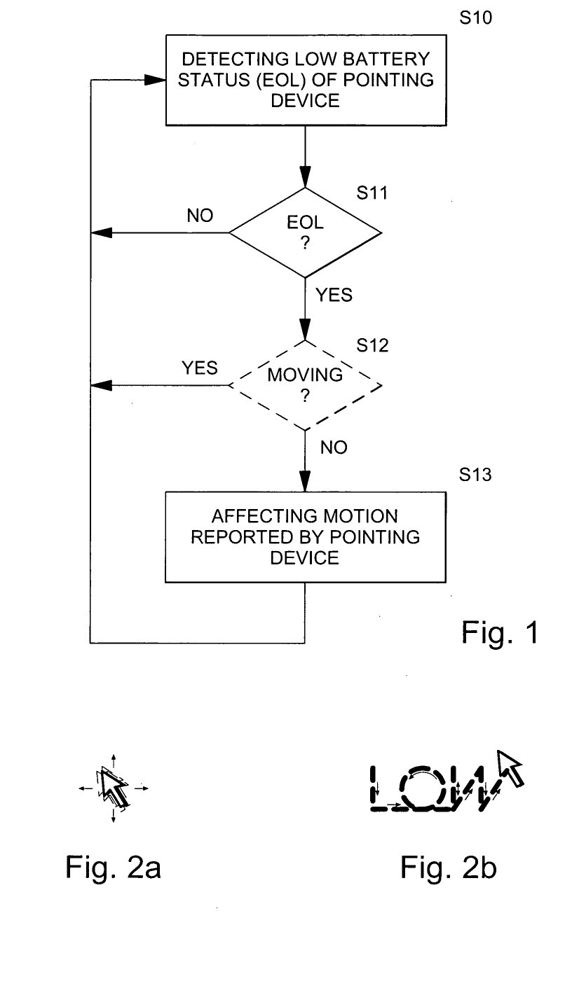

FIG. 1 illustrates one possible implementation of a method of providing indication of low battery status of a battery-powered pointing device which basically consists of affecting the motion reports outputted by the pointing device, upon detection of the low battery status, by adding determined and/or pseudo-random components of motion to the motion reports. It shall already be pointed out that affecting the motion reports outputted by the pointing device could be performed by the pointing device itself, the said determined and/or pseudo-random components of motion being programmed into the pointing device, or by a software application (or driver) installed on the computer with which the pointing device communicates.

The first step of the process (designated S10 in FIG. 1) consists of detecting the low battery status (or EOL—“End Of Life”—status) of the pointing device. Detection of the nearing end of life of the battery cells powering the pointing device can be performed by providing the pointing device with battery monitoring means for detecting when the power output of the battery cells (in terms of current and/or voltage output) falls below a certain threshold, or “EOL threshold”. Such battery monitoring means may be constructed in any suitable manner so as to monitor the battery output and provide the low battery status indication EOL when this output falls below the EOL threshold. This battery monitoring mechanism may be implemented as an additional function of an already existing unit of the pointing device (such as controlling unit or micro-controller of the pointing device), or alternatively as an integrated function of the power supply circuitry associated with the battery cells. The essential goal of the battery monitoring means is to provide the low battery status indication EOL when the battery cells near the end of their life. One should choose an adequate setting of the EOL detection threshold so that the low battery status EOL is detected at the optimal moment (not too early and not too late) so as to optimise usage of the battery cells. Advantageously, the EOL detection threshold might be adjusted or selected as a function of the type of battery or batteries used.

When low battery status EOL is detected (step S11) the process proceeds to step 13. As mentioned above, this step consists in this case of adding determined and/or pseudo-random components of motion to the motion that is reported by the pointing device.

Let us assume in the following that the pointing device controls motion of a cursor element on the computer screen (as this is usually the case for most applications of pointing devices), step 13 in FIG. 1 will affect the displacement behaviour of the cursor element on the computer screen. Within the scope of the invention, motion of the cursor element on the computer screen can be affected in various different ways, the essential goal being to efficiently draw the user's attention and give him or her an indication that something is wrong with the power supply of the pointing device.

FIGS. 2a and 2b schematically show two possible ways of affecting motion of a cursor element upon detection of the low battery status. As illustrated in FIG. 2a, one solution could consists in shifting the cursor element up-down and/or right-left around its current location on the computer screen. Other similar solutions may of course be envisaged, such as displacing the cursor element so that it follows a circular trajectory around its current location (or any other appropriate trajectory), or simply displacing the cursor element along any given direction so as to be relocated somewhere else. FIG. 2b shows another solution which consists in making the cursor element follow a determined trajectory so as to form a message on the screen (message “LOW” in this example). This other solution basically implies that the trace left by the cursor element on the computer screen be sufficiently persistent so as to be detected by the human eye. This depends on various factors such as the time taken by the cursor element to draw the message, the type of screen used (e.g. CRT or LCD display), the display refreshing rate, etc. In case the trace left by the cursor element is not sufficiently lasting or persistent on the screen, it could be possible to temporarily modify the graphical representation of the cursor element on the screen so that it generates a graphically more representative trace (e.g. by leaving a “shadow” or “mark” behind the cursor).

With a view to prevent interference with normal operations, it is preferable to affect the displacement or position of the cursor element so that its general location on the screen remains essentially the same. As a general rule, it is preferable to affect the “real” motion reported by the pointing device only for short durations, for example in a periodic manner or, preferably, when the pointing device is in a no-motion state (the motion reports outputted by the pointing device being zero). The low battery status indication will indeed be fed back to the user in a more efficient manner if the modification is not permanent, in particular if it is limited to periods where no motion is supposed to be reported by the pointing device. It is nevertheless possible to affect motion of the cursor element when it is moving, but this should preferably be done is such a way as not to disturb or interfere too much with normal operations.

Returning to FIG. 1, an optional step (step S12) is illustrated between steps 11 and 13. This step basically consists of testing whether or not motion is reported by the pointing device after the low battery status EOL has been detected and deciding to affect the reported motion (in this case zero motion) only if no motion has been detected or reported.

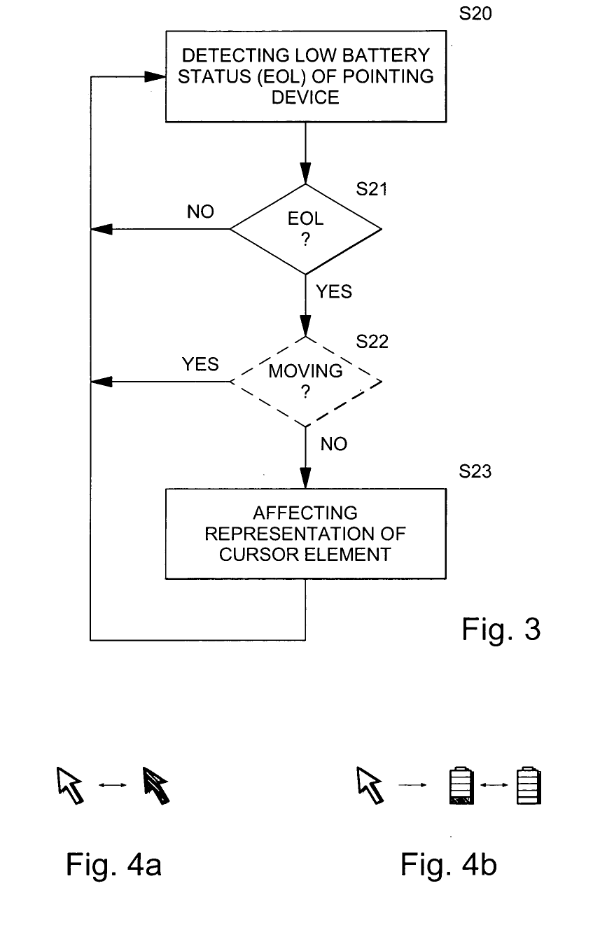

The above solutions may be implemented in essentially two ways, namely by programming the low battery status indication mechanism in the pointing device itself or in a software application or driver to be installed on the computer with which the pointing device communicates. An advantage of the first solution resides in the fact that the indication mechanism is fully integrated within the pointing device and does not require any specific driver to be installed or executed on the computer (except the standard driver typically provided with the operating system), the pointing device itself managing the way motion is affected upon detection of the low battery status. In this case, motion reported by the pointing device, upon detection of the low battery status, will already be affected before being provided to the computer and will consequently affect how objects are controlled on the computer screen. An advantage of the second solution resides in the fact that the software application may be designed so that the motion behaviour, in the low battery state, can be fully parameterised and can be combined with other mechanisms, such as a modification of the graphical representation of the cursor element on the computer screen (cf. FIGS. 3, 4a and 4b).

FIG. 3 illustrates another possible implementation of a method of providing indication of low battery status of a battery-powered pointing device used for controlling motion of a cursor element on a computer screen. In contrast to the previous implementation illustrated in FIG. 1, this implementation basically consists of affecting a graphical representation of the cursor element on the computer screen. It will be appreciated that this other implementation can be combined with the implementation of FIG. 1 so as to increase the “feedback efficiency” of the low battery status indication. One will however also understand that this other implementation necessitates installation of a specific driver on the computer with which the pointing device has to communicate.

Steps S20 to S22 of FIG. 3 are identical to steps S10 to S12 of FIG. 1 and will not accordingly be described again (step S22 being again optional). Step S23 differs in that it consists of affecting the graphical representation of the cursor element and does not imply, in this example, any modification of the motion reported by the pointing device.

The graphical representation of the cursor element in the low battery state may again be affected in various different ways, two non-limiting examples being illustrated in FIGS. 4a and 4b for the purpose of illustration only. One way of changing the graphical representation could for instance consist in switching the representation of the cursor element (or pointer) between at least two different representations, such as the normal bright arrow symbol (left part of FIG. 4a) and a dark arrow symbol (right part of FIG. 4a). As illustrated in FIG. 4b, the cursor symbol may alternatively be replaced by another symbol (for instance an empty battery symbol) which again can be switched between two graphical representations as illustrated on the right part of FIG. 4b. Other graphical representations may of course be envisaged, such as a “LOW BAT” symbol.

As mentioned above, the low battery status indication mechanism should preferably be implemented is such a way as not to interfere too much with normal operations (i.e. so that a user can still use his or her pointing device in a usual way). Besides, the low battery status indication should be activated at times where the probability that the user's attention is drawn to the cursor element and to the computer screen is the highest. In addition to acting on the cursor's motion and/or graphical representation during no-motion states or in a periodic manner (even when the pointing device is moving and is effectively reporting “real” motion), a proper moment for activation of the low battery status indication could advantageously be following wake-up of the pointing device from a stand-by state.

Having described the invention with regard to certain specific embodiments, it is to be understood that these embodiments are not meant as limitations of the invention. Indeed, various modifications and/or adaptations may become apparent to those skilled in the art without departing from the scope of the annexed claims.

1. A method of providing indication of low battery status of a battery-powered pointing device designed for detecting motion and outputting motion reports representative of the detected motion, said method comprising the steps of detecting low battery status of said pointing device and affecting output of said motion reports, upon detection of the low battery status, by adding determined and/or pseudo-random components of motion to said motion reports.

2. The method according to claim 1, wherein said determined and/or pseudo-random components of motion are programmed into said pointing device.

3. The method according to claim 1, wherein said determined and/or pseudo-random components of motion are added in one or the other of the following situations or manners:
only when motion detected by said pointing device is zero;
when motion detected by said pointing device is non-zero;
in a periodic manner; or
following wake-up of the pointing device from a stand-by state.

4. The method according to claim 1, wherein said pointing device controls motion of a cursor element on a computer screen and wherein said components of motion are determined so that said cursor element forms a specific message on said computer screen.

5. The method according to claim 1, wherein said pointing device controls motion of a cursor element on a computer screen and wherein a graphical representation of said cursor element is also affected upon detection of the low battery status.

6. A method of providing indication of low battery status of a battery-powered pointing device designed for detecting motion and outputting motion reports representative of the detected motion, said pointing device controlling motion of a cursor element on a computer screen, said method comprising the steps of detecting low battery status of said pointing device and affecting motion of said cursor element on said computer screen, upon detection of the low battery status, by adding determined and/or pseudo-random components of motion to the motion of said cursor element.

7. The method according to claim 6, wherein said determined and/or pseudo-random components of motion are programmed into said pointing device.

8. The method according to claim 6, wherein said determined and/or pseudo-random components of motion are added in one or the other of the following situations or manners:
only when motion detected by said pointing device is zero;
when motion detected by said pointing device is non-zero;
in a periodic manner;
following wake-up of the pointing device from a stand-by state

9. The method according to claim 6, wherein said components of motion are determined so that said cursor element forms a specific message on said computer screen.

10. The method according to claim 6, wherein a graphical representation of said cursor element is also affected upon detection of the low battery status.

11. A battery-powered pointing device for detecting motion and providing motion reports representative of the detected motion to a computer, said pointing device including means for detecting a low battery status of said pointing device and means for affecting output of said motion reports, upon detection of the low battery status, by adding determined and/or pseudo-random components of motion to said motion reports.

12. The pointing device according to claim 11, wherein said determined and/or pseudo-random components of motion are programmed into said pointing device.

13. A computer software application for installation on a computer and control of a battery-powered pointing device designed for detecting motion and providing the computer with motion reports representative of the detected motion, said software application controlling motion of a cursor element on a screen of said computer on the basis of the motion reports sent by said pointing device, wherein said software application includes a mechanism for affecting motion of said cursor element on said screen, upon detection of a low battery status indication provided by said pointing device, by adding determined and/or pseudo-random components of motion to the motion of said cursor element.

14. The software application according to claim 13, further including means for parameterising how and/or when motion of said cursor element is affected.

15. A method of providing indication of low battery status of a battery-powered pointing device designed for detecting motion and outputting motion reports representative of the detected motion, said pointing device controlling motion of a cursor element on a computer screen, said method comprising the steps of detecting low battery status of said pointing device and affecting, upon detection of the low battery status, a graphical representation of said cursor element on said computer screen.

16. The method according to claim 15, wherein said graphical representation of the cursor element is affected in one or the other of the following situations or manners:
only when motion detected by said pointing device is zero;
when motion detected by said pointing device is non-zero;
in a periodic manner;
following wake-up of the pointing device from a stand-by state

17. The method according to claim 15, further comprising the step of affecting output of said motion reports, upon detection of the low battery status, by adding determined and/or pseudo-random components of motion to said motion reports.

18. A computer software application for installation on a computer and control of a battery-powered pointing device designed for detecting motion and providing the computer with motion reports representative of the detected motion, said software application controlling motion of a cursor element on a screen of said computer on the basis of the motion reports sent by said pointing device, wherein said software application includes a mechanism for affecting a graphical representation of said cursor element on said screen, upon detection of a low battery status indication provided by said pointing device.

19. The software application according to claim 18, further including means for parameterising how and/or when said graphical representation is affected.
